(19) United States
(12) Patent Application Publication
(10) Pub. No.: US 2008/0004041 A1
(43) Pub. Date: Jan. 3, 2008

(54) Method and system for confirming location of lost wireless terminal

(75) Inventors: Kyung-Hwan Ahn, Buk-gu (KR); Bo-Kyung Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/649,270

(22) Filed: Jan. 4, 2007

(30) Foreign Application Priority Data
Jun. 30, 2006 (KR) 2006-61095

(51) Int. Cl. H04Q 7/20

(52) U.S. Cl. 455/456.1

(57) ABSTRACT

A method and apparatus for confirming a location of a lost wireless terminal is provided. A location confirmation request of the lost wireless terminal is received by a mobile communication network and identification information of the lost wireless terminal is transmitted to wireless terminals which have joined a location confirmation service of the lost wireless terminal. The wireless terminal which has joined the service searches for a wireless terminal corresponding to identification information coinciding with the identification information of the lost wireless terminal. The wireless terminal which has joined the service transmits a location of the previously searched for lost wireless terminal to the mobile communication network. The mobile communication network manages the received location of the lost wireless terminal.

### CROSS REFERENCE TO RELATED APPLICATION

This application claims the benefit under 35 U.S.C. §119(a) of a Korean Patent Application filed in the Korean Intellectual Property Office on Jun. 30, 2006 and assigned Serial No. 2006-61095, the entire disclosure of which is hereby incorporated by reference.

### BACKGROUND OF THE INVENTION

1. Field of the Invention

The present invention relates to a wireless terminal. More particularly, the present invention relates to a method and a system capable of discovering the location of a lost wireless terminal.

2. Description of the Related Art

A variety of communication means exist today. Wireless terminals are the most familiar and most useful type for users. Wireless terminals are mainly used for voice communication. However, various functions have been performed in wireless terminals with the development of technology. Accordingly, it is difficult to restrict the multifarious uses of a wireless terminal only to voice communication. For example, a user can perform moving picture communication by using a camera provided in a wireless terminal or watch multimedia broadcasting by using a Digital Multimedia Broadcasting (DMB) receiver. Networks for a wireless terminal have also been developed. A Local Area Network (LAN) facilitates small scale network communication between wireless terminals. Such a LAN includes ZigBee, Ultra Wide Band (UWB), Bluetooth, and Radio Frequency Identification (RFID), among others. Further, such a LAN may allow various multimedia data to be conveniently used and may also recognize the location of a communication partner or a specific object. The wireless terminal has been considered to be a communication device necessary for modern users since it provides various functions. In addition to providing various useful functions as described above, a wireless terminal may be small and slim depending on a user's preference. The existence of small and slim wireless terminals is expected to increase with the development of the technology of a wireless terminal. Wireless terminals that are small and slim are easily lost or misplaced. Such loss of a wireless terminal may cause great inconvenience and danger to a user because important personal information of a user may be accessed by unspecified people, in addition to the inability to use of voice communication and the loss of a communication device. As a result, the loss of a wireless terminal is detrimental to a user.

Accordingly, there is a need for an improved system and method for quick retrieval of lost wireless terminals.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and a system capable of quickly retrieving a lost wireless terminal by discovering the location of the lost wireless terminal and informing the lost wireless terminal's user of its location.

In accordance with one aspect of the exemplary embodiment of the present invention, a method for confirming a location of a lost wireless terminal is provided. A location confirmation request of the lost wireless terminal is received by a mobile communication network and identification information of the lost wireless terminal is transmitted to wireless terminals which have joined a location confirmation service of the lost wireless terminal. The wireless terminal which has joined the location confirmation service searches for a wireless terminal that corresponds to identification information of the lost wireless terminal. The wireless terminal that has joined the location confirmation service transmits a location of the previously searched for lost wireless terminal to the mobile communication network. The mobile communication network manages the received location of the lost wireless terminal.

In accordance with another aspect of the exemplary embodiment of the present invention, a method for confirming a location of a lost wireless terminal is provided. Identification information of the lost wireless terminal is transmitted by a user's wireless terminal to a mobile communication network. This identification information is input from a user. The identification information of the lost wireless terminal is transmitted by the mobile communication network to wireless terminals that have joined a location confirmation service of the lost wireless terminal. The wireless terminal that has joined the service searches for a wireless terminal that corresponds to identification information coinciding with the identification information of the lost wireless terminal. The wireless terminal that has joined the location confirmation service transmits a location of the previously searched for lost wireless terminal to the mobile communication network. The mobile communication network manages the received location of the lost wireless terminal.

In accordance with further another aspect of an exemplary embodiment of the present invention, a method for confirming a location of a lost wireless terminal in a wireless terminal is provided. A location confirmation mode of the lost wireless terminal is entered. Location confirmation information of wireless terminals, which can perform Local Area Network (LAN) communication for a wireless terminal, in the location confirmation mode of the lost wireless terminal is confirmed. If a location of the lost wireless terminal is confirmed as a result of confirming the location confirmation information, location confirmation information of a user's wireless terminal is updated to terminate the location confirmation of the lost wireless terminal. If a location of the lost wireless terminal is not confirmed, the location confirmation information of the user's wireless terminal is updated to continue the location confirmation of the lost wireless terminal.

In accordance with still another aspect of an exemplary embodiment of the present invention, a system for confirming a location of a lost wireless terminal is provided. The system comprises a mobile communication network and a wireless terminal. The mobile communication network transmits identification information of the lost wireless terminal to wireless terminals which have joined a location confirmation service of the lost wireless terminal. The mobile communication network receives a location of the lost wireless terminal from the wireless terminals which have joined the location confirmation service and manages the location of the lost wireless terminal. A wireless terminal receives the identification information of the lost wireless terminal from the mobile communication network, confirms identification information of wireless terminals capable of performing Local Area Network (LAN) communication, searches for the lost wireless terminal, and transmits the location of the found lost wireless terminal to the mobile communication network.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram illustrating a wireless terminal according to an exemplary embodiment of the present invention;

FIG. 2 is a diagram illustrating a connection between a mobile communication network and a wireless terminal according to an exemplary embodiment of the present invention;

FIG. 3 is a diagram illustrating a LAN connection between wireless terminals according to an exemplary embodiment of the present invention;

FIG. 4 is a flow diagram illustrating a method for confirming the location of a lost wireless terminal according to a first exemplary embodiment of the present invention; and

FIG. 5 is a flow diagram illustrating a method for confirming the location of a lost wireless terminal according to a second exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

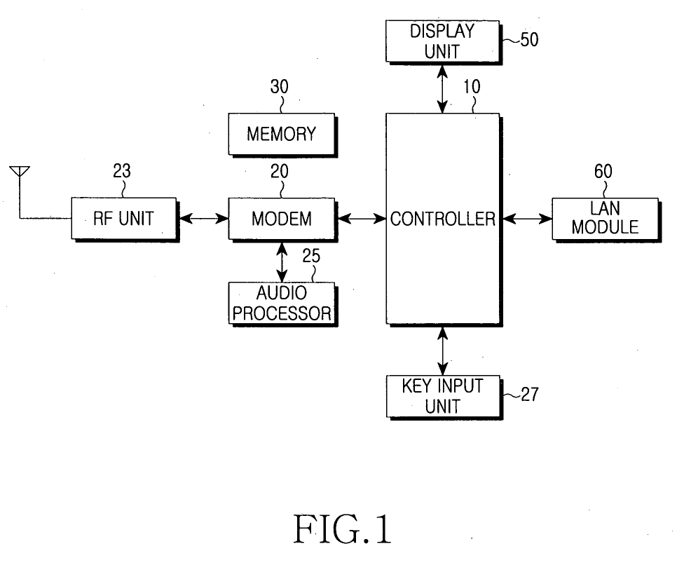

FIG. 1 is a block diagram illustrating a wireless terminal according to an exemplary embodiment of the present invention.

Referring to FIG. 1, a Radio Frequency (RF) unit 23 includes an RF transmitter for up-converting and amplifying the frequency of transmitted signals, an RF receiver for low-noise amplifying received signals and down-converting the frequency of the received signals, among other operations.

A modem 20 includes a transmitter for coding and modulating signals to be transmitted, and a receiver for demodulating and decoding signals received in the RF unit 23, among others.

An audio processor 25 may include a codec. The codec includes a data codec for processing packet data and an audio codec for processing audio signals such as voice. The audio processor 25 converts digital audio signals received through the modem 20 into analog signals through the audio codec for reproduction. Alternatively, the audio processor 25 converts analog audio signals generated from a microphone into digital audio signals through the audio codec and transmits the digital audio signals to the modem 20. The codec may be separately provided or included in a controller 10.

A key input unit 27 includes keys for inputting numeral and character information and function keys for setting various functions.

A memory 30 may include a program memory and a data memory. The program memory stores programs for controlling general operations of the wireless terminal. The memory 30 according to the exemplary embodiment of the present invention stores both identification information of a user's wireless terminal and identification information of a lost wireless terminal. The identification information of each wireless terminal may be a Mobile Identification Number (MIN) and Electronic Serial Number (ESN) of a wireless terminal. The identification information may also be a user ID of a service, in which the location of a lost wireless terminal can be confirmed, or user personal information, such as a phone number or resident registration number. The memory 30, according to the exemplary embodiment of the present invention, stores location confirmation information as illustrated in Tables 1 to 4. Basically, location confirmation information has a format as illustrated in Table 1, in which all wireless terminals store only their own identification information. The location confirmation information as illustrated in Tables 2 to 4 denotes location confirmation information derived from that of Table 1 according to results obtained by confirming the location of a lost wireless terminal according to the exemplary embodiment of the present invention. The IDs commonly expressed in Tables 1, 3 and 4 denote identification information of a wireless terminal itself, the S0 in Tables 2 and 3 denotes that location confirmation of a lost wireless terminal is not necessary. In Table 4, S1 denotes that location confirmation of a lost wireless terminal must be continued, P1 includes information about the current location of a lost wireless terminal, and L-ID denotes identification information of a lost wireless terminal.

TABLE 1
ID

TABLE 2

| | |
|---|---|
| S0 | L-ID |

TABLE 3

| | | |
|---|---|---|
| S0 | L-ID | ID |

TABLE 4

| | | | |
|---|---|---|---|
| S1 | P1 | L-ID | ID |

A display unit 50 may use a Liquid Crystal Display (LCD), and Organic Light Emitting Diodes (OLED), among others. The display unit 50 outputs various display information generated in the wireless terminal. When the LCD or OLED has a touch screen function, the display unit 50 may also operate as an input unit to control the wireless terminal, together with the key input unit 27.

A LAN module 60 is a communication module enabling LAN communication between wireless terminals. The LAN module 60, according to the exemplary embodiment of the present invention, exchanges various information necessary for location confirmation of a lost wireless terminal. In an exemplary embodiment of the present invention, the LAN module 60 may be a LAN including ZigBee, UWB, Bluetooth or RFID. According to an exemplary embodiment of the present invention, the LAN module 60 is assumed to have a RFID reader capable of reading and recording a RFID TAG when the RFID has been used. Location confirmation information is also confirmed and recorded through the RFID reader.

The controller 10 switches and controls the general operation and operation mode of the wireless terminal. According to the exemplary embodiment of the present invention, the controller 10 switches into a location confirmation mode of the lost wireless terminal, confirms identification information of wireless terminals within the LAN, and searches for the lost wireless terminal if identification information of a lost wireless terminal is received. If the location of the lost wireless terminal is found, the controller 10 transmits the found location of the lost wireless terminal to the mobile communication network 210 or wireless terminals within the LAN. Herein, the controller 10 generates location confirmation information to facilitate a quick search for the location of the lost wireless terminal and to prevent an unnecessary search for the location of the lost wireless terminal after the location search is completed. According to the exemplary embodiment of the present invention, the controller 10 provides a User Interface (UI) through which the location of the specific lost wireless terminal can be confirmed, and displays the location of the lost wireless terminal to a user based on input identification information of the lost wireless terminal.

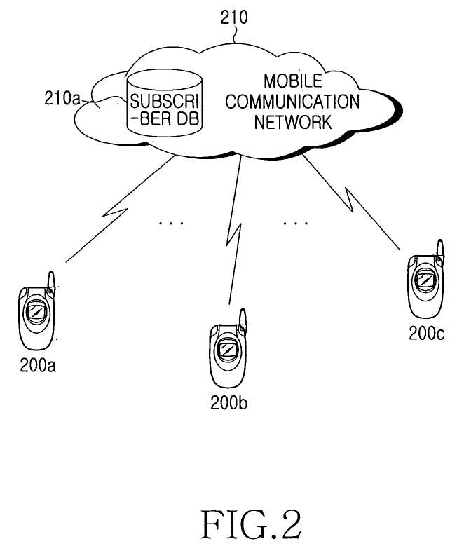

FIG. 2 is a diagram illustrating a connection between a mobile communication network and a wireless terminal, according to one of the exemplary embodiments of the present invention.

Referring to FIG. 2, the mobile communication network 210 denotes a communication network providing a mobile communication environment. That is, the mobile communication network 210, according to an exemplary embodiment of the present invention, provides a mobile communication environment to wireless terminals 200a to 200c. The mobile communication network 210, according to the exemplary embodiment of the present invention, includes a subscriber Database (DB) 210a. The subscriber DB 210a denotes a DB for storing information about wireless terminals of users who have joined a location confirmation service of a lost wireless terminal, and which can confirm the location of the lost wireless terminal. The information stored in the subscriber DB 210a may also include the MIN and ESN of a wireless terminal, user information of a Universal Subscriber Identify Module (USIM) card, user information of a User Information Module (UIM) card, and user information of a Subscriber Identification Module (SIM) card. However, the MIN and ESN may be illegally copied, and a subscriber identification module such as a USIM card may be lost or replaced. It is assumed that the subscriber DB 210a stores a user ID of a service, personal information (e.g., phone number or resident registration number) of a user, and the identification number of the LAN module 60, among others. It is assumed that the wireless terminals 200a to 200c use a mobile communication environment through a connection with the mobile communication network 210, and belong to different LANs or the same LAN of each wireless terminal.

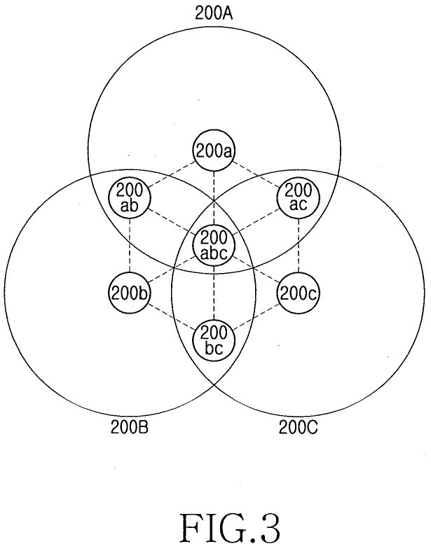

FIG. 3 is a diagram illustrating a LAN connection between wireless terminals according to the exemplary embodiment of the present invention.

FIG. 3 illustrates a coverage of LAN communication of the wireless terminals 200a, 200b and 200c. According to FIG. 3, the wireless terminals are also interconnected. The coverage of LAN communication depends on the type of the LAN module 60. Referring to FIGS. 2 and 3, the LAN coverage 200A denotes a coverage in which LAN communication is possible based on the wireless terminal 200a, the LAN coverage 200B denotes a coverage in which LAN communication is possible based on the wireless terminal 200b, and the LAN coverage 200C denotes a coverage in which LAN communication is possible based on the wireless terminal 200c. The wireless terminal 200bc denotes a wireless terminal that commonly belongs to the LAN coverage 200B and 200C. Likewise, the wireless terminal 200ac denotes a wireless terminal that simultaneously belongs to the LAN coverage 200A and 200C, the wireless terminal 200ab denotes a wireless terminal that simultaneously belongs to the LAN coverage 200A and 200B, and the wireless terminal 200abc denotes a wireless terminal that simultaneously belongs to the LAN coverage 200A, 200B and 200C. According to an exemplary implementation, the LAN coverage, to which a specific wireless terminal belongs and a list of wireless terminals, which belong to a LAN change since the location of the wireless terminal changes.

Hereinafter, the exemplary embodiment of the present invention will be described in detail through the wireless terminal connected to the mobile communication network and the LAN as described above. The exemplary embodiment of the present invention will be described referring to an operation subject of the wireless terminal as the wireless terminal, instead of the controller 10 of the wireless terminal.

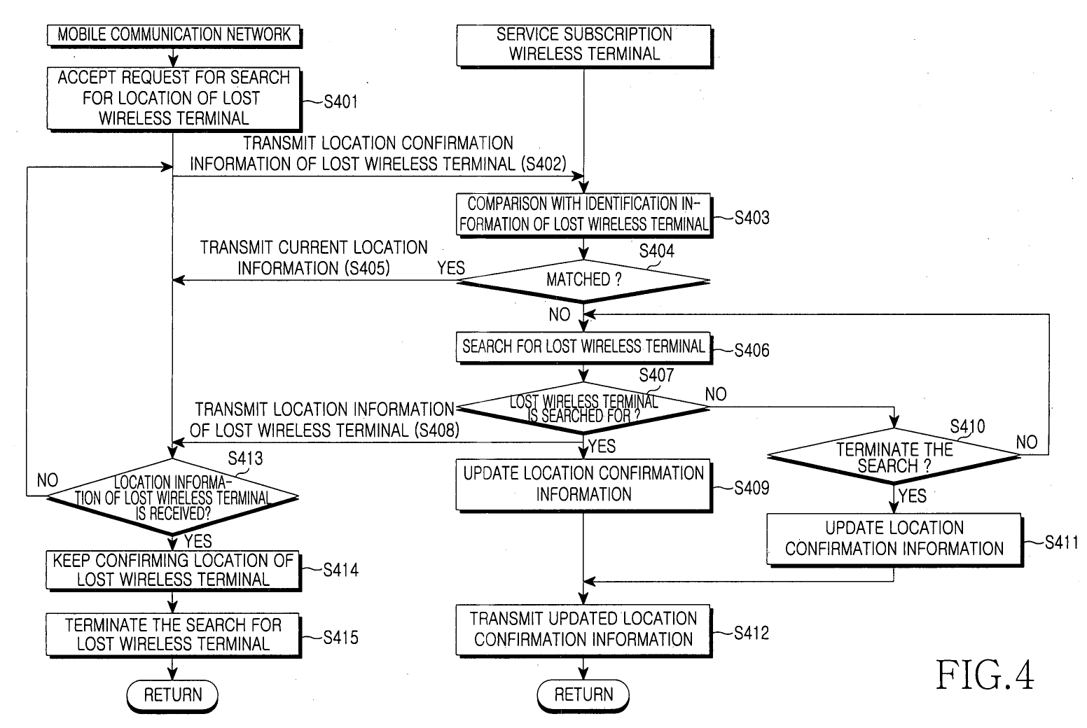

FIG. 4 is a flow diagram illustrating a method for confirming the location of a lost wireless terminal according to a first exemplary embodiment of the present invention.

Referring to FIGS. 2 to 4, if a request for location confirmation of a lost wireless terminal is accepted (S401), the mobile communication network 210 transmits location confirmation information of the lost wireless terminal to wireless terminals which have joined a location confirmation service of a lost wireless terminal (S402).

If a user who has lost a wireless terminal requests a provider of the mobile communication network 210 to confirm the location of the lost wireless terminal, the mobile communication network 210 confirms information of all wireless terminals which have joined a location confirmation service. For example, if the user reports the lost wireless terminal, the mobile communication network 210 confirms information of all wireless terminals which have joined a location confirmation service (hereinafter, referred to as a service) of a lost wireless terminal, which is stored in the subscriber DB 210a. Then, the mobile communication network 210 transmits location confirmation information as illustrated in Table 2 to the wireless terminals which have joined the service. The location confirmation information includes identification information of the lost wireless terminal. According to an exemplary implementation, the mobile communication network 210 transmits a guidance message that represents an indication that a search is being conducted for the lost wireless terminal. The mobile communication network 210 also transmits the location confirmation information as illustrated in Table 2, thereby requesting wireless terminals that have not joined the service to also help the location confirmation of the lost wireless terminal. Accordingly, the wireless terminals that have not joined the service can perform the following steps for confirming the location of the lost wireless terminal under the consent of users.

A service subscriber's wireless terminal which has received the location confirmation information from the mobile communication network 210 compares its own identification information with the identification information of the lost wireless terminal (S403), and determines if the two types of identification information match each other (S404).

The service subscriber's wireless terminal which has received the location confirmation information as illustrated in Table 2 determines that the location confirmation of the lost wireless terminal has not yet been terminated, compares the identification information (e.g., the L-ID of Table 2) of the lost wireless terminal with the identification information (e.g., the ID of Table 1) of the service subscriber's wireless terminal, and determines if the service subscriber's wireless terminal matches the lost wireless terminal.

If the service subscriber's wireless terminal matches the lost wireless terminal, the service subscriber's wireless terminal transmits its own location to the mobile communication network 210 (S405).

The service subscriber's wireless terminal may also transmit only information about a current location to the mobile communication network, but may also generate location confirmation information as illustrated in Table 4 and transmit the generated location confirmation information to the mobile communication network. In steps 404 and 405, when the service subscriber's wireless terminal matches the lost wireless terminal, the lost wireless terminal can report its own location.

If the service subscriber's wireless terminal does not match the lost wireless terminal, the service subscriber's wireless terminal searches for the lost wireless terminal (S406).

When a determination is made that the service subscriber's wireless terminal does not match the lost wireless terminal in step 404, the service subscriber's wireless terminal confirms location confirmation information of wireless terminals located in the LAN coverage, to which the service subscriber's wireless terminal belongs as illustrated in FIG. 3. For example, if a service subscriber's wireless terminal that has initially received the location confirmation information of the lost wireless terminal from the mobile communication network 210 is the wireless terminal 200a, the wireless terminal 200a confirms the location confirmation information of the wireless terminals 200ab, 200abc and 200ac within the LAN 200A to which the wireless terminal 200a belongs, and searches for the lost wireless terminal. That is, the service subscriber's wireless terminal compares the identification information of each wireless terminal included in the location confirmation information received from each wireless terminal with the identification information of the lost wireless terminal, thereby searching for the lost wireless terminal. In order to search for the lost wireless terminal, the service subscriber's wireless terminal 200a may receive the location confirmation information from the wireless terminals 200ab, 200abc and 200ac, or may also directly read and confirm the location confirmation information stored in the wireless terminals 200ab, 200ac and 200abc, according to the type of the LAN module 60. For example, when the LAN module used in the exemplary embodiment of the present invention is ZigBee, UWB or Bluetooth, an operation for confirming the location of the lost wireless terminal can be performed by requesting location confirmation information and transmitting/receiving the requested location confirmation information. This may be performed since the location confirmation information corresponding to Tables 1 to 4 are simple data packets. If the LAN module 60 used in the exemplary embodiment of the present invention is RFID, a service subscription wireless terminal allows the RFID reader to project a specific frequency and to perform a search for the location of the lost wireless terminal by reception of RFID tag information of a wireless terminal within a LAN which reacts to the specific frequency.

The service subscriber's wireless terminal determines whether the lost wireless terminal is searched for through step 406 (S407), and transmits the location of the lost wireless terminal, the location of which has been confirmed, to the mobile communication network 210 (S408).

That is, the service subscriber's wireless terminal searches for the lost wireless terminal through step 406, and transmits the location information of the lost wireless terminal to the mobile communication network 210 when a search has been conducted for the lost wireless terminal. Herein, the location information of the lost wireless terminal may also be included in location confirmation information and transmitted to the mobile communication network 210. Only the location information of the lost wireless terminal may also be transmitted to the mobile communication network 210.

If step 408 is completed, the service subscriber's wireless terminal updates the location confirmation information (S409).

After transmitting the location of the lost wireless terminal to the mobile communication network 210, the service subscriber's wireless terminal can update its own location confirmation information as illustrated in Table 4. That is, the service subscriber's wireless terminal can update its own location confirmation information as new location confirmation information obtained by adding all information (e.g., S1 of Table 4), representing that it no longer necessary to search for the location of the lost wireless terminal, and the identification information and location information (e.g., P1 of Table 4) of the lost wireless terminal to the identification information of the service subscriber's wireless terminal. Herein, the transmission of step 408 and the update of step 409 can be reversed in sequence. In this update of the location confirmation information, if the LAN module 60 of the wireless terminal is ZigBee, UWB or Bluetooth, the service subscriber's wireless terminal stores the updated location confirmation information in a memory or a separate storage space. However, if the LAN module 60 of the wireless terminal is RFID, the service subscriber's wireless terminal controls a RFID reader to store the updated location confirmation information in a RFID tag.

If a search for the lost wireless terminal is no longer conducted, the service subscriber's wireless terminal determines whether to terminate the location confirmation of the lost wireless terminal (S410). If the location confirmation of the lost wireless terminal is terminated, the service subscriber's wireless terminal updates the location confirmation information of the lost wireless terminal (S411).

For example, referring to FIG. 3, if the wireless terminal 200a determines that the wireless terminals 200ab, 200abc and 200ac included in the LAN coverage 200A are not the lost wireless terminal, the wireless terminal 200a terminates the search for the lost wireless terminal. Before the search for the lost wireless terminal is terminated, the wireless terminal 200a can continue to search for the location confirmation information of the wireless terminals within the LAN coverage 200A by preset times or during preset time periods. The wireless terminal 200a searches for the lost wireless terminal during preset time periods or by preset times, so that the probability to search for the lost wireless terminal in the LAN coverage 200A increases with the movement of the wireless terminal 200a. Then, the wireless terminal 200a updates its own location confirmation information as location confirmation information as illustrated in Table 3. The wireless terminal 200a updates its own location confirmation information storing only the identification information thereof as location confirmation information that includes the identification information of the lost wireless terminal and information representing the necessity to continue to search for the lost wireless terminal because the location of the lost wireless terminal has not yet been confirmed.

The service subscriber's wireless terminal transmits the location confirmation information updated in steps 409 or 411 to the wireless terminals within the LAN or the mobile communication network 210 (S412).

The service subscriber's wireless terminal may also transmit the location confirmation information updated in step 410 to the wireless terminals within the LAN or the mobile communication network 210. However, the transmission step of the updated location confirmation information may be omitted based on the type of the LAN or for quick location confirmation of the lost wireless terminal. When the location confirmation information updated in step 409 is transmitted to the mobile communication network 210 or the LAN, it is possible to allow certain wireless terminals, which have received the location confirmation request of the lost wireless terminal, to omit an operation for reconfirming the location of the lost wireless terminal, the location of which has been already confirmed. When multiple service subscribers' wireless terminals have confirmed the location of the lost wireless terminal, the mobile communication network 210 is aware of the detailed location of the lost wireless terminal.

If the location information of the lost wireless terminal is received through steps 405 or 408 (S413), the mobile communication network 210 manages the location of the lost wireless terminal (S414).

If the location information of the lost wireless terminal is received, the mobile communication network 210 reports the location of the lost wireless terminal to the user of the lost wireless terminal, which is stored in a partner having performed the request of step 401 or the subscriber DB 210a. Then, the mobile communication network 210 continues to confirm the location of the lost wireless terminal until the lost wireless terminal is retrieved. In order to confirm a changing location of the lost wireless terminal, the mobile communication network 210 may use a speech path formed between the mobile communication network 210 and the lost wireless terminal, or may request a service subscriber's wireless terminal having succeeded in confirming the location of the lost wireless terminal to continuously confirm and transmit the location of the lost wireless terminal.

After step 414, the mobile communication network 210 transmits information, representing the termination of location confirmation of the lost wireless terminal, to a service subscriber's wireless terminals (S415).

The mobile communication network 210 may transmit information that causes a service subscriber's wireless terminals to terminate the search for the lost wireless terminal. This is to prevent an operation for confirming the location of the lost wireless terminal after the lost wireless terminal is retrieved, and to continue to confirm the location of the lost wireless terminal until the lost wireless terminal is retrieved since the location of the lost wireless terminal may continuously change.

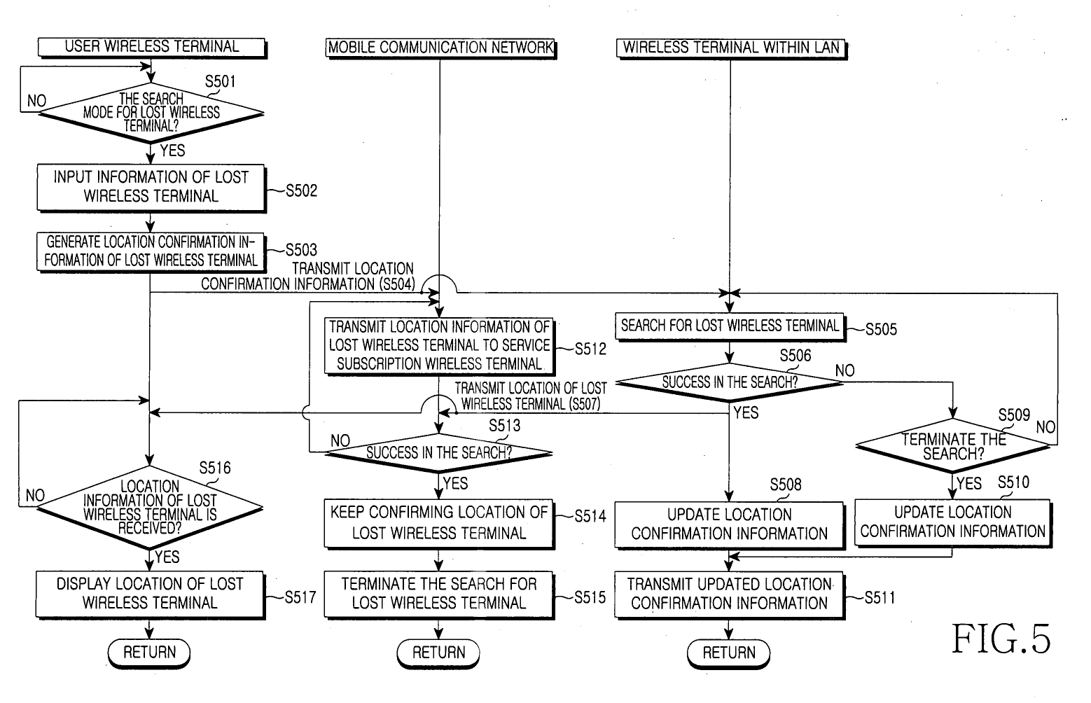

FIG. 5 is a flow diagram illustrating a method for confirming the location of a lost wireless terminal according to a second exemplary embodiment of the present invention. In the second exemplary embodiment of the present invention, the location of the lost wireless terminal can be confirmed even without a mobile communication network, but the location of the lost wireless terminal is confirmed in cooperation with the mobile communication network for quicker location confirmation.

After entering a location confirmation mode of the lost wireless terminal (S501), a user's wireless terminal receives information about the lost wireless terminal from a user (S502).

The user's wireless terminal receives the identification information of the lost wireless terminal from the user in the search mode for the lost wireless terminal. The user can determine a location of lost wireless terminal or input identification information of the lost wireless terminal in the search mode for the lost wireless terminal.

The user's wireless terminal generates location confirmation information of the lost wireless terminal from the received identification information of the lost wireless terminal (S503), and transmits the generated location confirmation information to the mobile communication network 210 or wireless terminals within the LAN (S504).

That is, the user's wireless terminal generates location confirmation information as illustrated in Tables 2 or 3 from the identification information of the lost wireless terminal, which is input from a user, and transmits the generated location confirmation information to a mobile communication network or a wireless terminal within the LAN including the user's wireless terminal.

A service subscriber's wireless terminal that has received the location confirmation information of the lost wireless terminal through step 504 searches for the lost wireless terminal (S505), and determines whether successful search results of the lost wireless terminal are obtained (S506). If the search is successful, the location of the lost wireless terminal is transmitted (S507).

In step 505 a search for the lost wireless terminal is performed in a manner similar to that of steps 403 to 406 in FIG. 4, except for the fact that the transmission corresponding to step 405 is performed for the user's wireless terminal as well as the mobile communication network 210 in step 505.

The location confirmation information is updated according to the search results of the lost wireless terminal in steps 508 to 510 in a manner similar to that of steps 409 to 411 in FIG. 4.

The wireless terminal within the LAN transmits the location confirmation information updated in steps 508 to 510 to the mobile communication network 210 or other wireless terminals within the LAN including the wireless terminal (S511).

Since the wireless terminal 200ab, 200ac, 200bc or 200abc of FIG. 3 is included in at least one LAN coverage, exchange of the location confirmation information of the lost wireless terminal performed among the wireless terminals is quickly implemented in all LAN coverages. For example, if a user of the wireless terminal 200a transmits the location confirmation information of the lost wireless terminal to the wireless terminal 200b, the transmitted location confirmation information is transmitted to all wireless terminals within the LAN coverage 200A, 200B and 200C.

Steps 512 to 515 in which the mobile communication network 210 searches for the lost wireless terminal to confirm the location of the lost wireless terminal are performed in a manner similar to that of steps 413 to 415 in FIG. 4. However, in step 512 in which the mobile communication network 210 transmits the location confirmation information of the lost wireless terminal to service a subscriber's wireless terminals, wireless terminals within all LANs, to which the user's wireless terminal does not belong or which are far from the user's wireless terminal, search for the lost wireless terminal.

If the location confirmation information of the lost wireless terminal is received (S516), the user's wireless terminal outputs the location of the lost wireless terminal to a user (S517).

After transmitting the location confirmation information in step 504, if the user's wireless terminal is in a waiting mode or performs functions based on a user's input and receives the location confirmation information of the lost wireless terminal, the user's wireless terminal reports the location of the lost wireless terminal to the user.

According to an exemplary embodiment of the present invention as described above, wireless terminals capable of performing LAN communication cooperate with one another to quickly and precisely determine and report the location of a lost wireless terminal, so that the lost wireless terminal can be easily retrieved.

While the present invention has been shown and described with reference to certain exemplary embodiments thereof, it will be understood by those skilled in the art that various changes in form and details may be made therein without departing from the scope and spirit of the invention as defined in the appended claims and their equivalents.

What is claimed is:

1. A method for confirming a location of a lost wireless terminal, the method comprising:
receiving, by a mobile communication network, a location confirmation request of the lost wireless terminal, and transmitting identification information of the lost wireless terminal to wireless terminals that have joined a location confirmation service of the lost wireless terminal;
searching for, by the wireless terminal that has joined the location confirmation service, a wireless terminal corresponding to identification information that matches the identification information of the lost wireless terminal;
transmitting, by the wireless terminal that has joined the location confirmation service, a location of the lost wireless terminal searched for in the searching to the mobile communication network; and
managing, by the mobile communication network, the received location of the lost wireless terminal.

2. The method as claimed in claim 1, wherein the receiving comprises:
confirming, by the mobile communication network that has received the location confirmation request of the lost wireless terminal, the wireless terminals that have joined the location confirmation service from a service database; and
transmitting, by the mobile communication network, the identification information of the lost wireless terminal to the wireless terminals that have joined the location confirmation service.

3. The method as claimed in claim 1, wherein the searching comprises:
receiving, by the wireless terminal that has joined the location confirmation service, the identification information of the lost wireless terminal, and confirming identification information of wireless terminals that has joined the location confirmation service through Local Area Network (LAN); and
searching for, by the wireless terminal that has joined the location confirmation service, the wireless terminal corresponding to the identification information that matches the identification information of the lost wireless terminal.

4. The method as claimed in claim 3, further comprising:
comparing, by the wireless terminal that has joined the location confirmation service, its own identification information with the received identification information of the lost wireless terminal; and
transmitting, by the wireless terminal that has joined the location confirmation service, its own location to the mobile communication network by itself if the two types of identification information match each other.

5. The method as claimed in claim 1, wherein the transmitting comprises:
transmitting, by the wireless terminal that has joined the location confirmation service, the location of the lost wireless terminal searched for in the searching to the mobile communication network; and
continuing to confirm location variation of the lost wireless terminal until receiving instructions to terminate the location confirmation of the lost wireless terminal, updating the location of the lost wireless terminal depending on the location variation, and transmitting the updated location to the mobile communication network.

6. The method as claimed in claim 1, wherein the managing comprises:
substantially continuously confirming, by the mobile communication network, the location variation of the lost wireless terminal; and
transmitting, by the mobile communication network, the information to terminate the location confirmation of the lost wireless terminal; and
reporting, by the mobile communication network, the location of the lost wireless terminal to a user of the lost wireless terminal.

7. The method as claimed in claim 1, wherein the identification information comprises at least one of a Mobile Identification Number (MIN), Electronic Serial Number (ESN), user personal information or RFID tag of each wireless terminal.

8. The method as claimed in claim 3, wherein a LAN comprises one of Bluetooth, ZigBee, Ultra Wide Band (UWB) and Radio Frequency Identification (RFID).

9. A method for confirming a location of a lost wireless terminal in a wireless terminal, the method comprising:
determining to enter a location confirmation mode of the lost wireless terminal;
confirming location confirmation information of wireless terminals through Local Area Network (LAN) communication for a wireless terminal, in the location confirmation mode of the lost wireless terminal;
if a location of the lost wireless terminal is confirmed as a result of confirming the location confirmation information, primarily updating location confirmation information to terminate location confirmation of the lost wireless terminal; and
if a location of the lost wireless terminal is not confirmed, secondarily updating the location confirmation information to continue the location confirmation of the lost wireless terminal.

10. The method as claimed in claim 9, wherein the location confirmation information comprises at least one of its own identification information of the each wireless terminal, identification information of the lost wireless terminal, information to continue to the location confirmation of the lost wireless terminal, information to terminate the location confirmation of the lost wireless terminal or the location of the lost wireless terminal.

11. The method as claimed in claim 9, wherein the primarily updated location confirmation information stores at least one of the its own the identification information of the each wireless terminal, identification information of the lost wireless terminal, information to terminate the location confirmation of the lost wireless terminal or the location of the lost wireless terminal.

12. The method as claimed in claim 9, wherein the secondarily updated location confirmation information stores at least the its own the identification information of the each wireless terminal, the identification information of the lost wireless terminal or information to continue the location confirmation of the lost wireless terminal.

13. The method as claimed in claim 9, wherein the determining comprises:
if location confirmation information of the lost wireless terminal is received from a mobile communication network, comparing identification information of the lost wireless terminal comprised in the received location confirmation information with identification information of the wireless terminal, and determining if the two types of identification information correspond to each other;
if the two types of identification information do not correspond with each other, entering a location confirmation mode of the wireless terminal.

14. The method as claimed in claim 13, further comprising:
if the two types of identification information correspond with each other, transmitting the location of the lost wireless terminal to the mobile communication network; and
not entering a location confirmation mode of the wireless terminal.

15. The method as claimed in claim 14, further comprising, if the location of the lost wireless terminal is transmitted to the mobile communication network because the two types of identification information match each other, primarily updating location confirmation information of the wireless terminal, and transmitting the primarily updated location confirmation information to wireless terminals within the LAN.

16. The method as claimed in claim 15, wherein the primarily updated location confirmation information stores at least one of the its own the identification information of the wireless terminal, identification information of the lost wireless terminal or the its own location of the wireless terminal.

17. The method as claimed in claim 9, further comprising transmitting at least one of the primarily updated location confirmation information and the secondarily updated location confirmation information to at least one of the mobile communication network and wireless terminals within a LAN.

18. The method as claimed in claim 9, wherein the identification information comprises at least one of a Mobile Identification Number (MIN), Electronic Serial Number (ESN, user personal information or RFID tag of each wireless terminal.

19. The method as claimed in claim 9, wherein a LAN comprises one of Bluetooth, ZigBee, Ultra Wide Band (UWB) and Radio Frequency Identification (RFID).

20. A system for confirming a location of a lost wireless terminal, the system comprising:
a mobile communication network for transmitting identification information of the lost wireless terminal to wireless terminals that have joined a location confirmation service of the lost wireless terminal, receiving a location of the lost wireless terminal from the wireless terminals that have joined the location confirmation service, and managing the location of the lost wireless terminal; and
a wireless terminal for receiving the identification information of the lost wireless terminal from the mobile communication network, confirming identification information of wireless terminals through Local Area Network (LAN) communication, searching for the lost wireless terminal, and transmitting the location of the found lost wireless terminal to the mobile communication network.

21. The system as claimed in claim 20, wherein the mobile communication network comprises a subscriber database storing identification information of the wireless terminals that have joined the location confirmation service of the lost wireless terminal.

22. The system as claimed in claim 20, wherein, if the location of the lost wireless terminal is received, the mobile communication network transmits instructions to terminate the location confirmation of the lost wireless terminal to the wireless terminals that have joined the location confirmation service.

23. The system as claimed in claim 20, wherein the wireless terminal comprises:
a LAN module for confirming identification information of the wireless terminals through the LAN communication, and detecting locations of the wireless terminals; and
a controller for searching for a lost wireless terminal corresponding to the identification information of the lost wireless terminal through the LAN module, confirming the location of the lost wireless terminal, and controlling the location of the lost wireless terminal to be transmitted to the mobile communication network.

24. The system as claimed in claim 23, wherein the LAN module comprises one of Bluetooth, ZigBee, Ultra Wide Band (UWB) and Radio Frequency Identification (RFID).

25. The system as claimed in claim 23, further comprising a memory for storing at least one of the identification information of the lost wireless terminal and the identification information of the wireless terminal.

26. The system as claimed in claim 25, wherein the memory further storing at least one of the information to continue the location confirmation of the lost wireless terminal or the information to terminate the location confirmation of the lost wireless terminal.

27. The system as claimed in claim 23, wherein the controller compares the identification information of the lost wireless terminal with the identification information of the wireless terminal, and controls the wireless terminal to report its own location by itself if the two types of identification information match each other.

28. The system as claimed in claim 20, wherein the identification information comprises at least one of a Mobile Identification Number (MIN), Electronic Serial Number (ESN), user personal information or RFID tag of each wireless terminal.
